(19) United States
(12) Patent Application Publication
(10) Pub. No.: US 2006/0005684 A1
(43) Pub. Date: Jan. 12, 2006

(54) Paper cutting and trimming apparatus with replaceable, horizontally-oriented, decorative-edged cutting shears

(76) Inventors: James B. Cox, Glendora, CA (US); David M. Johnson, Ontario, CA (US)

Correspondence Address: ERIC HANSCOM, 7395 PORTAGE WAY, CARLSBAD, CA, 92011, US

(21) Appl. No.: 10/937,471

(22) Filed: Sep. 10, 2004

Related U.S. Application Data
(60) Provisional application No. 60/585,870, filed on Jul. 6, 2004.

(51) Int. Cl. B26D 1/30

(52) U.S. Cl. 83/607

(57) ABSTRACT

A device for cutting flat substances, such as paper, photographs and cardboard, adapted to provide a variety of decorative edged cuts. The cutting edges of the invention are arranged horizontally to enhance not only the quality and continuity of the decorative cuts, but also a user's ability to safely operate the invention. Cutting edges are optionally replaceable and can be stored in specially adapted holders located on the underside of the base plate cutting surface.

### CROSS REFERENCE TO RELATED APPLICATIONS

This Utility Patent Application is based upon Provisional Application No. 60/585,870 filed on Jul. 6, 2004.

### STATEMENT REGARDING FEDERALLY SPONSORED RESEARCH OR DEVELOPMENT

This invention was not federally sponsored.

### FIELD OF THE INVENTION

This invention is directed toward a paper cutting and trimming apparatus with replaceable decorative-edged cutting shears, which can be used conveniently and safely to provide a wide variety of decorative edged cuts in paper, cardboard, photos, and other flat objects.

### BACKGROUND OF INVENTION

It was not long after humans learned to cut paper that they probably began experimenting with methods of creating decorative edges to enhance the messages, poems, or artwork they put on the paper as a way to convey messages and feelings to others. While today the means by which people communicate with others has expanded dramatically beyond simple paper objects—from the telephone to the internet—a nicely arranged note or poem on a piece of paper with an artistically created decorative edge remains a classic way to pass on a thought to another person. Today, the fabrication of ornamentally configure paper objects is a basic element of every elementary and secondary school curriculum. Additionally, the rising popularity of “scrap booking”, that is, creatively collecting and sharing personal memories through exchange of hand-crafted scrapbooks has put a further premium on methods of creating decoratively shaped edges to paper, cardboard, and other flat materials. It has been reported that nearly 25% of U.S. households participate in “scrap booking” in one form or another, resulting in an industry which has increased in volume from $1.4 billion in 2002 to $2.55 billion in 2004.

The basic instruments used to cut paper, cardboard, and other flat materials are scissors and paper cutters. Most scissors have straight cutting surfaces, resulting in straight cuts. Cropping scissors have been manufactured to add a decorative edge in a variety of shapes to trimmed objects. However, since the average cut length from cropping scissors is around four inches, it is necessary to realign the scissors with each section cut so that the patent of the cut flows artistically from one cut to another. A failure by the user to take the time to line up each cut will result in a trimmed edge which will be marred every four inches by a pattern which abruptly stops and is continued with an incongruous section of the same pattern. In addition, a failure to line up each cut so as to continue the pattern may lead to torn or ripped edges, further destroying the artistic look desired by the user. An additional problem with cropping scissors is that the blades are not interchangeable, thereby forcing a person wanting to make a variety of decorative edged cuts to buy a variety of cropping scissors.

Another method of attempting to make decorative cuts is found in lining up a knife blade over an ornamental pattern, then using the knife to trace out and cut the paper, using the ornamental pattern as a guide. This method, in addition to the inherently safety concerns surrounding have a user, particularly a young child, using a knife sharp enough to cut paper, is limited by the manual dexterity of the user.

Thus, there has existed a need for a safe and efficient means to make decorative edged cuts on paper, cardboard, and other flat materials.

There exists prior art which discloses a number of inventions which have tried to accomplish this goal. For example, U.S. Pat. No. 5,865,928 by Lariviere teaches the use of a template having a plurality of patterns, mounding at least one graphic art object with adhesive-coated substrate to form a work piece, arranging the template over the work piece, and then drawing a cutting blade along the portion of the template defining the selected pattern, to cut along lines conforming to the selected pattern. While Lariviere's device was intended to cut collage puzzle pieces, it does effectively offer a method of putting decorative edges on flat objects such as paper and cardboard. Due to its reliance on sharp cutting knives, held in the hand by a user, it presents obvious safety concerns and would prove very time consuming should a user want to use one of the cutting channels to create the edge to a postcard or letter.

U.S. Pat. No. 6,722,051 to Carlson concerns a shape cutting system comprising a blade assembly positioned to engage at least one periphery and the edge of an opening of a template, thereby enabling the blade to cut a shape in the material which assimilates the shape of at least a portion of the periphery and edge of the template. While Carlson's invention at least partially alleviates the traditional safety concerns by having the cutting blade recessed within a cutting unit, the device is used for cutting out decorative shapes rather than providing decorative edges to flat materials.

Other shape-cutting devices include U.S. Pat. Nos. 5,733,081 and 5,100,270 to Dowdle, which deal, again, with cutting apertures in mat board rather than trimming decorative edges onto paper and cardboard, and U.S. Pat. No. 4,056,025 to Rubel, which teaches a method of cutting strip material in a straight line, rather than decorative edges.

Paper cutters are traditionally guillotine-like devices with a flat base plate and a partially rotatable lever arm, both of which have vertically aligned cutting blades which cut paper and other objects in a guillotine-like fashion. Unfortunately, along with paper these cutting devices can also cut fingers and other undesired cutting objects which are mistakenly laid in the path of the blades. While most paper cutters now come with safety devices in the form of raised barriers intended to prevent a user from accidentally cutting his or her fingers in the paper cutter, the reliance upon two vertically aligned, sharp cutting blades continues to prove a danger to children, those with limited dexterity, and heavy industrial users of these devices who desire to pay low liability insurance rates.

For example, U.S. Pat. No. 3,301,117 to Spaulding teaches a device for cutting sheet material such as paper and cardboard which is designed for safe use by children. With Spaulding's device, the sheet to be cut is placed upon a base with one side positioned against a guide rule fixed in the top surface of the board and extending perpendicularly to the rail, which has detachable blades within a blade holder mounted therein. When the rail is moved downward to clamp the sheet against the board, the lower cutting edges of the blades extending into the slot formed in the board sever the sheet as the blade holder is moved along the board. By recessing the blade within a sliding cutting unit, this invention also alleviates at least some of safety concerns, but it can only make a straight cut—not the decorative edged cuts made possible by the current invention.

Another approach to the safety issue is disclosed by U.S. Pat. No. 5,320,011 to Lee. This device is a paper cutter having a safety device, which comprises a safety latch movably attached to a cutting arm which has a safety latch base catch for engaging with a bottom surface of an extended portion of the base, an arm catch for engaging with the top surface of the arm, and a trigger for allowing a user to rotate the safety latch about the axis point to a position where the base catch disengages the extended base portion. As with Spaulding's invention, Lee's device enhances the safe operation of a method of cutting paper, but allows for only straight-edged cuts to be made.

The current invention meets the long-felt need for a paper cutting and trimming apparatus with decorative-edged cutting shears, which can be used conveniently and safely to provide a wide variety of decorative edged cuts in paper, cardboard, photos, and other flat objects, and to do so with cutting templates long enough to avoid the necessity of lining up cropping scissors every four or five inches. The current invention goes beyond meeting this need, by also teaching a system by which a variety of decorative edges can be cut by one device through the use of interchangeable cutting assemblies, which are stored in a convenient series of channels underneath the invention's base plate.

### BRIEF SUMMARY OF INVENTION

It is therefore an object of this invention to provide a paper cutting and trimming apparatus with decorative-edged cutting shears, which can be used conveniently and safely to provide a wide variety of decorative edged cuts in paper, cardboard, photos, and other flat objects.

It is a further object of this invention that a single device can provide numerous edge shapes through the use of easily exchanged cutting assemblies.

It is a final object of this invention that the cutting assemblies that are not being used can be stored efficiently in slots manufactured into the bottom of the base plate of the invention.

Other and further objects and features of this invention will be apparent to one skilled in the art.

### BRIEF DESCRIPTION OF THE FIGURES

FIG. 1 is a top view of the invention showing the major external parts.

FIG. 2 is a top view, partial cut-away showing the receiving slot and the base plate blade assembly as it can be locked in place.

FIG. 3 is a side view of the base plate and the base plate blade assembly showing how the beveled edge allows for easy insertion and removal of the blade assembly.

FIG. 4 is an expanded, partial view of the point of connection between the lever and the base plate.

FIG. 5 is a top view of the base plate blade assembly illustrating the various parts.

FIG. 6 is an end view of the base plate blade assembly.

FIG. 7 is a top view of the base plate blade assembly being inserted into the base plate.

FIG. 8 is a cut-away side view of the lever and base plate being moved to bring the blade assemblies together to cut paper or another flat material.

FIG. 9 is a bottom view of the lever, showing the lever receiving slot, into which a lever blade assembly can be inserted.

FIG. 10 is an end view of the lever showing the lever receiving slot.

FIG. 11 is a top view of the lever blade assembly.

FIG. 12 is an end view of the lever blade assembly.

FIG. 13 is a top view of a blade assembly inserted into a receiving slot, showing how the locking portion of the handle slides over and locks behind a lock projection manufactured into the base plate.

FIG. 14 is a top view of a pair of scalloped cutting edges.

FIG. 15 is a top view of a pair of triangularly shaped cutting edges.

### DETAILED DESCRIPTION OF THE INVENTION

The present invention is directed to a device for cutting flat substances, such as paper, photographs and cardboard, adapted to provide a variety of decorative edged cuts. The cutting edges of the invention are arranged horizontally to enhance not only the quality and continuity of the decorative cuts, but also a user's ability to safely operate the invention. Cutting edges are replaceable and can be stored in specially adapted holders located on the underside of the cutting surface.

Referring to the drawings the invention consists of a flat base plate, cross-hatched with a grid which can be used for measuring cuts and lining up the material to be cut. One end of the base plate is raised to form a guide edge to provide an edge against which the material is stabilized for measuring and cutting. The invention has a lever arm which is rotatably attached to one end of the base plate. On the lever arm is a means of attachment into which can be slid a variety of lever arm blade assemblies, each of which has built into it a different decorative edge. As a counterpart to each of the different decorative edges on the lever arm blade assemblies, there is a matching base plate decorative edge built into a base plate blade assembly. The lever arm blade assembly and the base plate blade assembly are manufactured such that the blades mate in a cutting action in a horizontal manner, which not only avoids the danger inherent in the “guillotine cut” of traditional paper cutters, but also allows for a unique, reciprocal cutting method which allows for clean decorative cuts. Both of the blade assemblies slide into dove-tailed receiving slots, and have handles with locking mechanisms which allow a user to quickly and efficiently insert, lock for use, then remove the blade assemblies which the user wishes to use another blade assembly with a different decorative edge.

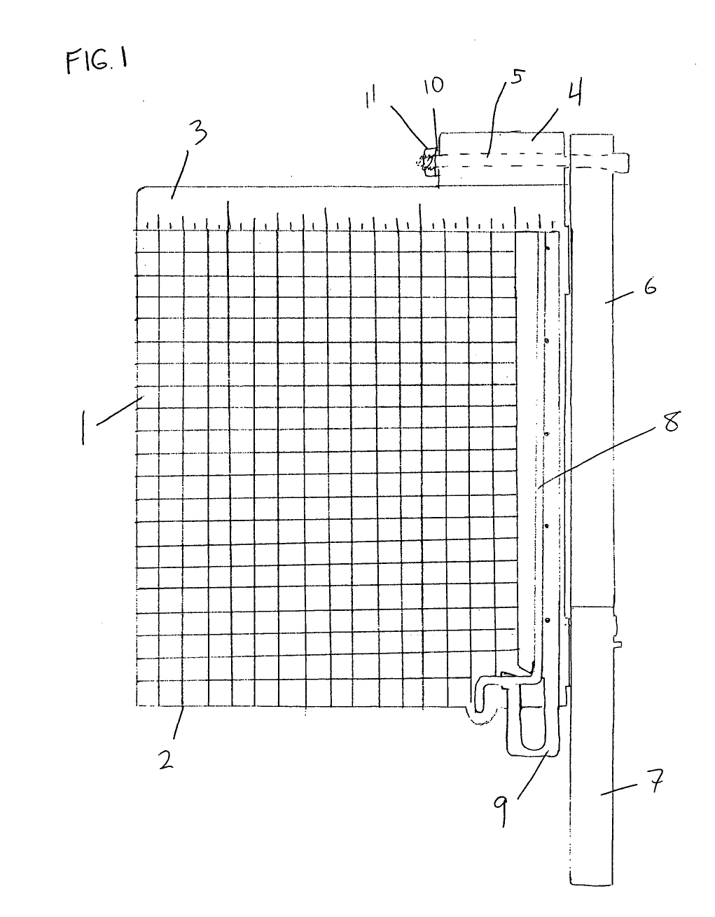

FIG. 1 is a top view of the invention showing its major parts, as visible from a common perspective looking down upon the invention. There is a base plate (1) which is a flat piece of metal, plastic, or similar sturdy material. Upon the surface of the base plate is a series of cross-hatched gridlines (2) which can be either embedded into the surface of the base plate and/or printed on the base plate during its manufacture. Along one edge of the base plate, there is a raised guide edge which rises out of the base plate at a 90 degree angle, and serves as a guide against which the material to be cut is laid for measuring and to assure a straight cut. The raised guide edge has a measuring device (3), or ruler, which can be either embedded into the surface of the base plate and/or printed on the base plate during its manufacture. On the edge of the base plate which has the raised guide there is also a block (4), through which there is a hole (not shown in this figure), through which a bolt (5) slides and attaches to the block a lever arm (6). A spring washer (10) and lock nut (11) are used to tighten and secure the bolt on the other side of the block.

The lever arm extends the length of the base plate and terminates in a handle (7) which allows a user to convenient raise and lower the lever arm to cut flat materials placed on the base plate. There is a safety guard (8) which prevents a user's fingers from getting to the edge of the horizontal cutting implements (not shown in this figure). There is also a base plate cutting assembly (9), which will be discussed and described in more detail in additional figures.

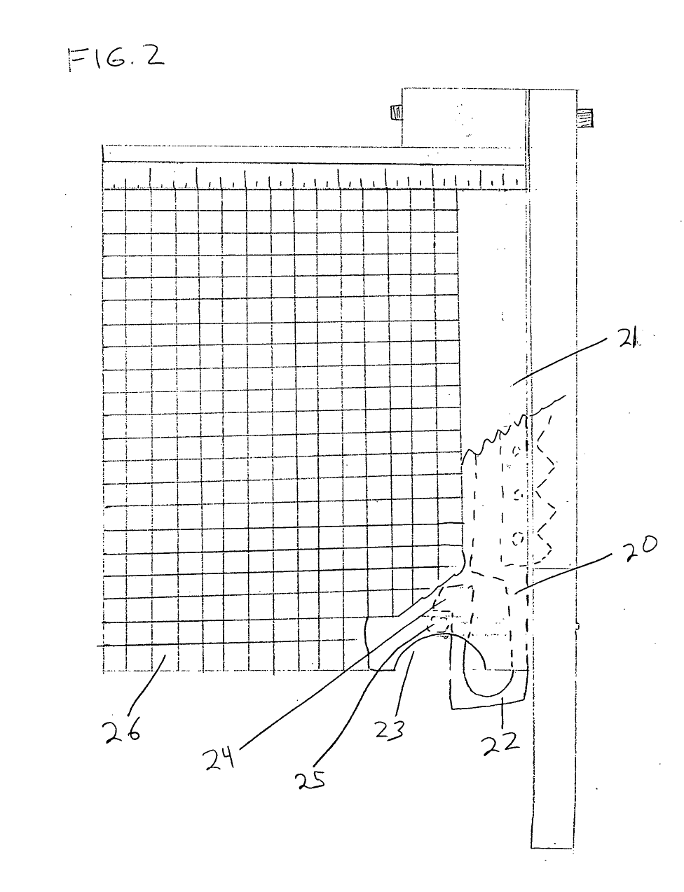

FIG. 2 is a partial cut-away top view of the invention showing how a base plate blade assembly (20) slides into a base plate receiving slot (21) manufactured into the base plate. The base plate blade assembly has a handle (22) which a user can grab to efficiently install and remove the base plate blade assembly. Into the base plate there is manufactured an indentation (23) which allows a user to easily grab the handle portion of the base plate blade assembly. To lock the base plate blade assembly (20) into the base plate receiving slot (21), there is a lock (24) on the handle (22). The lock (24) passes over a lock protuberance (25) which is manufactured into the base plate (26).

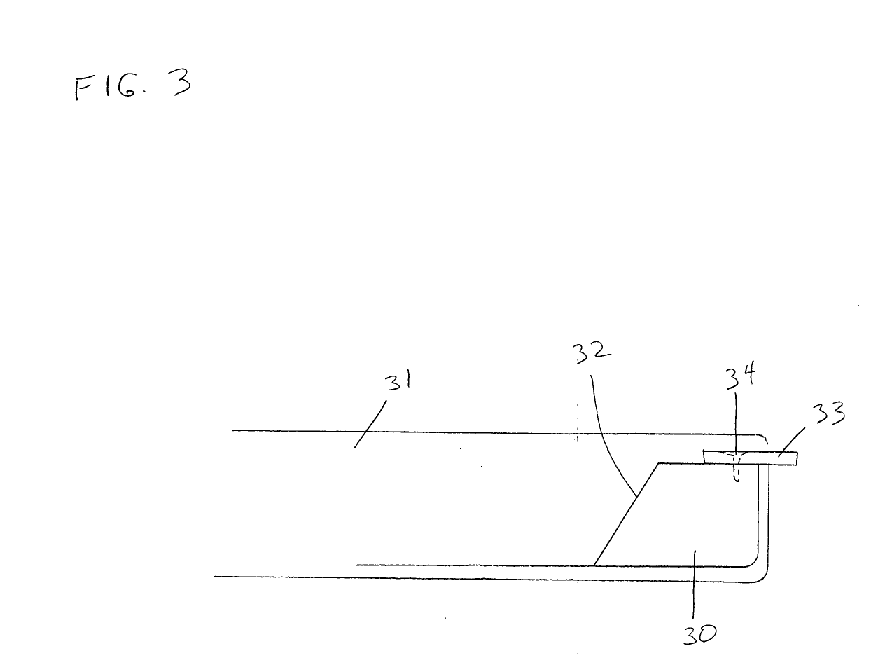

FIG. 3 is an end view of the invention showing a recessed receiving slot manufactured into the base plate, which allows a user to slide in a variety of base plate blade assemblies, each with a different decorative edge for cutting purposes. This view shows the base plate blade assembly (30) slid into the base plate receiving slot (32) which is build into the base plate (31). Attached by screws or rivets (34) to the top of the base plate blade assembly (30) is a base plate blade assembly (33).

FIG. 4 is a close-up of the bolt assembly by which the handle (40) is attached to the block (41). A bolt (42) is threaded through a hole in the handle. The hole in the handle has a recessed enlarged section (43) into which the head of the bolt fits, thereby ensuring that the head of the bolt does not project beyond the outside edge of the handle. This recessed enlarged section is shaped like the shape of the bolt head, which is in normal cases a hexagon, such that the bolt, once inserted into the recessed enlarged section, does not turn. On the other side of the block (41) there is a spring washer (44) which is slid over the threaded end of the bolt, and a lock nut (45) which is tightened over the threaded end of the bolt such that the handle is attached to the block in a manner which is loose enough to allow the handle to rotate, but not so loose as to adversely impact the intended precise alignment of the lever arm blade assembly and the base plate blade assembly.

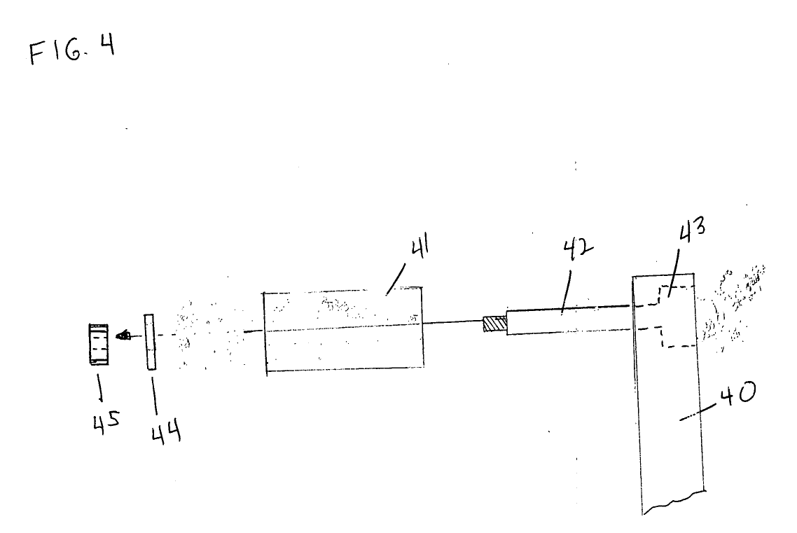

FIG. 5 is a top view of an easily exchangeable blade assembly. There is a beveled section (50) which is manufactured with an angle which matches the angle manufactured into the base plate receiving slot or the lever receiving slot, depending upon whether the particular blade assembly is made to be used in the lever or base plate. There is a handle (51) and a lock (52) which allow a user to insert the blade assembly into the receiving slot and lock it in place until the user wishes to remove it and replace it with another blade assembly with a different decorative edge cutting apparatus. The handle is shaped in a rough semi-circle and is made of plastic, fiberglass, or a similar flexible yet sturdy material such that the lock (52) can be pressed in with a user's thumb to lock and unlock from the receiving slot with relative ease, the direction of movement indicated by number (53). The assembly has a flat portion (54) onto which a cutting assembly (55) is mounted with screws, rivets, or a similar means of attachment (56) On the edge of the cutting assembly is a decorative cutting edge, called a base plate cutting edge (57), which can be made in a wide variety of shapes, each of which mate with a reciprocal decorative cutting edge found on its counterpart which fits into the lever or base plate, whichever is not the intended location for this particular blade assembly. The handle (51), lock (52), beveled section (50) and flat portion (54) are collectively known as the blade assembly member.

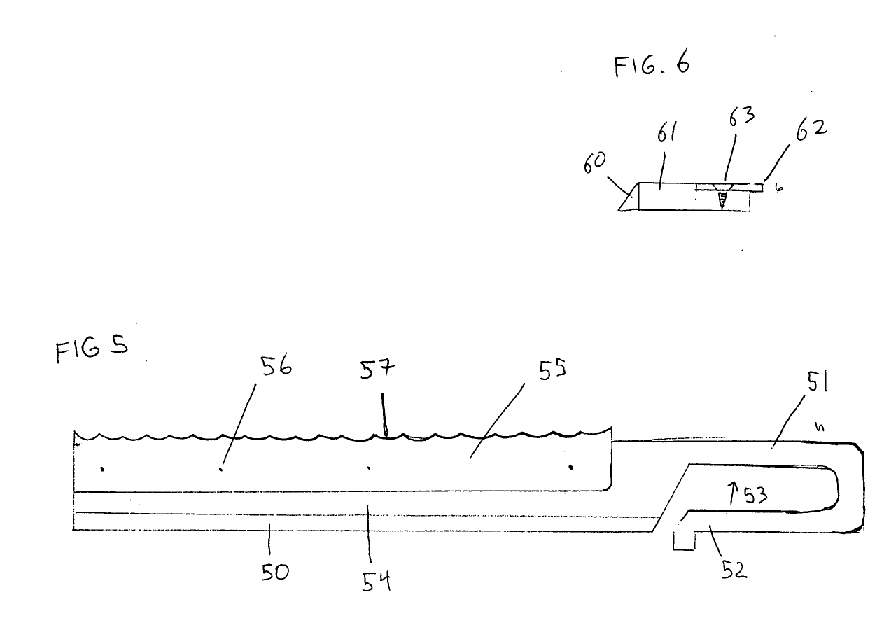

FIG. 6 is a cross section of the exchangeable blade assembly, showing the beveled section (60) which slides into a reciprocal receiving slot on either the lever or base plate (neither is shown in this figure). There is also a flat portion (61) onto which is attached a decorative cutting edge (62), the means of attachment (63) being screws, rivets or a similar means of attachment. On the edge of the decorative cutting edge protruding over the edge of the flat portion (61) is the decorative cutting edge (62), which can be manufactured in a variety of shapes to produce a variety of cuts. The fact that the cutting blade is laid out horizontally—as opposed to the guillotine-like vertical blades found in traditional paper cutters—is an important part of this invention.

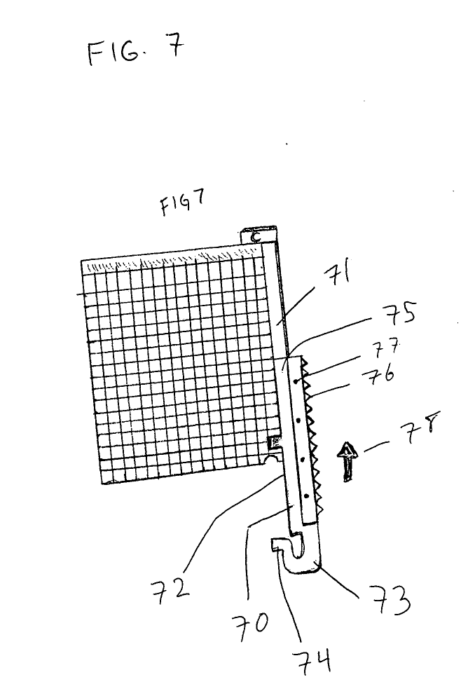

FIG. 7 is a top view of the invention with the handle removed. This view shows a base plate blade assembly (70) partially inserted into a base plate receiving slot (71). The base plate blade assembly has a beveled edge (72), a handle (73), a lock (74) which locks the base plate blade assembly into the base plate, a flat portion (75), a decorative cutting blade (76) attached to the base plate blade assembly with attachment means (77). The base plate blade assembly (70) is slid into the base plate receiving slot (71) in a direction indicated by number (78).

FIG. 8 is an end view of the base plate blade assembly, showing how the decorative cutting edges are aligned in a horizontal manner, as opposed to the guillotine-like vertical blades of traditional paper cutters. There is a base plate decorative cutting edge (80) which lines up with a lever decorative cutting edge (81) when the lever (86) is moved in a downward direction (84), the two decorative cutting edges meeting at a cutting point (85). The beveled edge (81) of the base plate blade assembly is also shown to illustrate how it allows the base plate blade assembly to be slid into the base plate receiving slot which also has a beveled surface (87) which mates with the beveled edge (81) of the base plate blade assembly (89). The lever (86) also has a receiving slot (88) which accommodates the beveled edge (82) of the lever blade assembly is also shown to illustrate how it allows the lever blade assembly to be slid into the lever receiving slot which also has a beveled surface (82) which mates with the beveled edge (82) of the lever blade assembly.

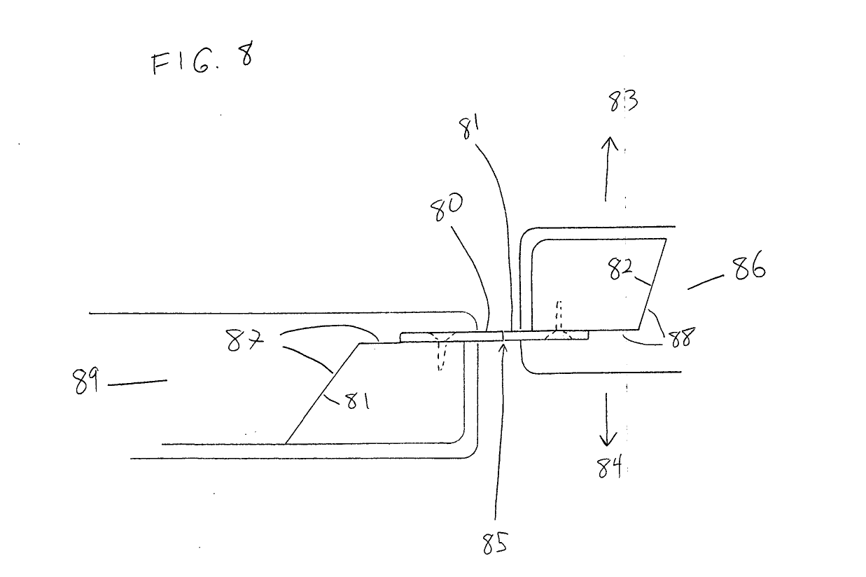

FIG. 9 illustrates how the lever (90) is positioned with a vertical orientation prior to receiving the lever blade assembly. At one end of the lever is a handle (95); at the other end the lever is attached to the base plate (96) at a block (93). On the underside of the lever (90), there exists a lever blade assembly receiving slot (91), which has a beveled edge (92) and a lock projection (94) over which a lever blade assembly is slipped to lock it into position.

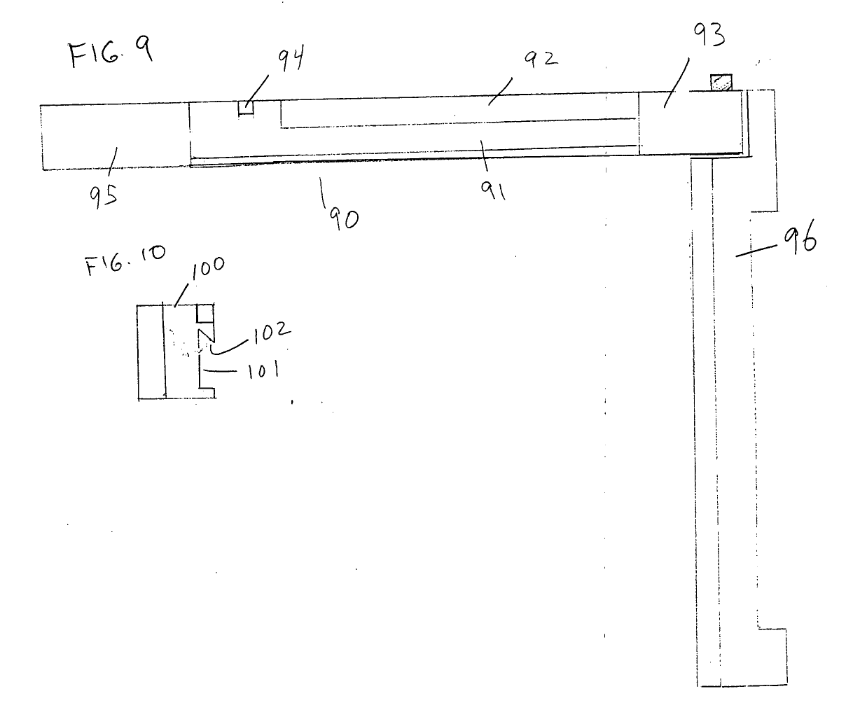

FIG. 10 is an end view of the lever (100), showing the lever blade assembly receiving slot (101) with its beveled edge (102).

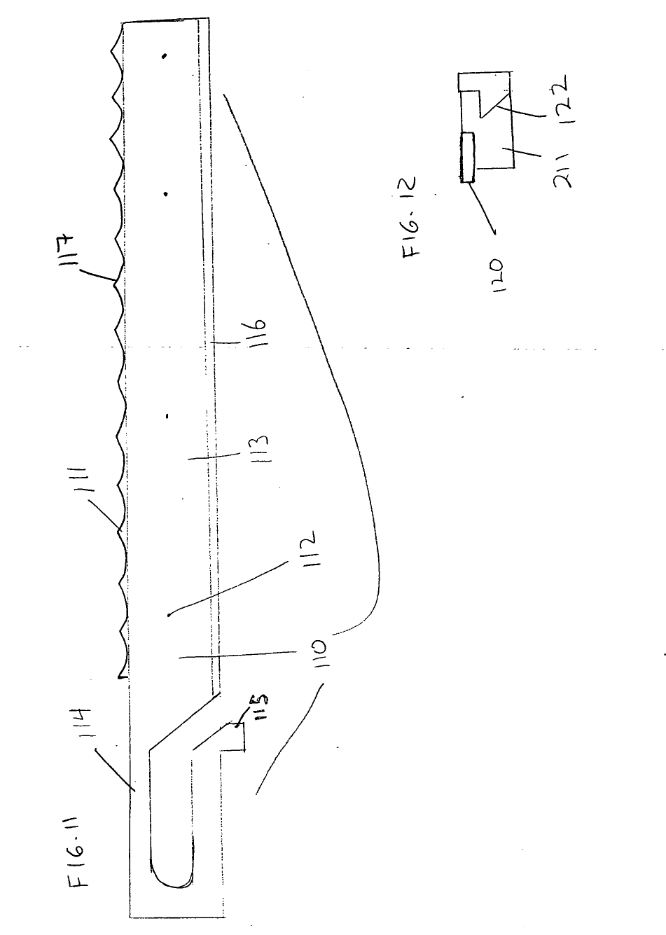

FIG. 11 is a top view of the lever blade assembly (110), which consists of a decorative cutting blade (111), the outer edge of which is a lever cutting edge (117), attached by, in this iteration, rivets (112), to a flat portion (113). There is a beveled surface (116) which fits into the lever receiving slot (not shown in this figure), and a handle (114) with a locking section (115).

FIG. 12 is an end view of the lever blade assembly of FIG. 11, showing the horizontal orientation of the decorative cutting edge (120) coming out of the lever blade assembly main member (121), and the beveled surface (122) showing an angle which allows it to mate with the angle in the lever receiving slot (not shown in this iteration).

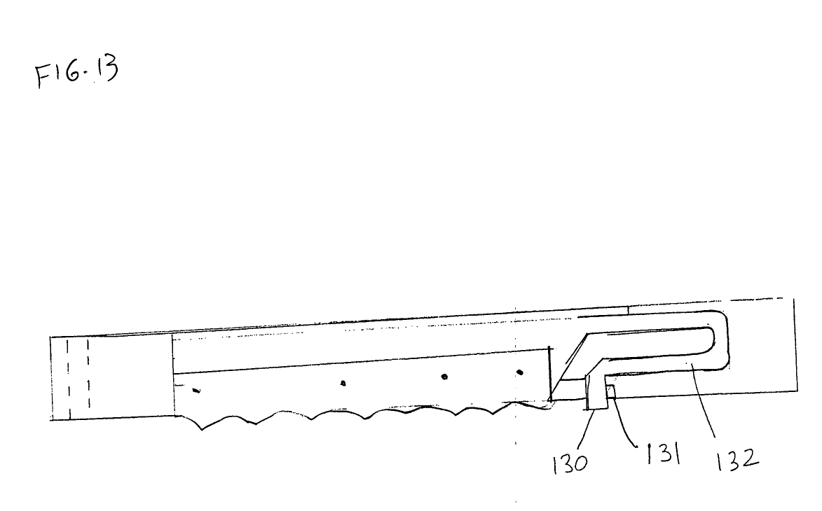

FIG. 13 is a top view of the lever with a lever blade assembly inserted into the lever receiving slot. The lock (130) of the lever blade assembly is flexible enough to slide over a lock projection (131) which is manufactured into the lever. The handle of the lever blade assembly (132) is flexible enough to bend and allow the lock (130) to be slid over the lock projection (131).

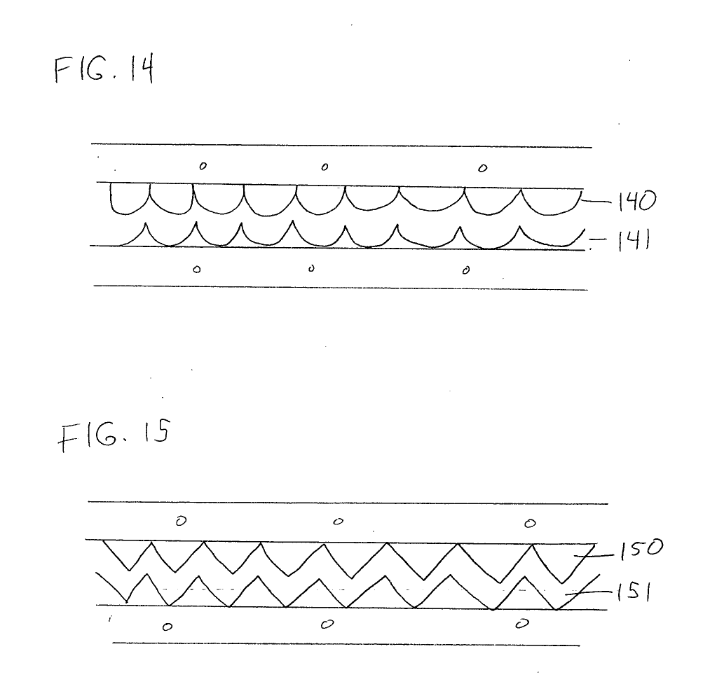

FIG. 14 is a partial, side view of one iteration of the cutting edges. Here, one blade assembly has a scalloped cutting edge (140), which mates with the reciprocal cutting edge (141) on the mating blade assembly. The scalloped portions (140) on one blade assembly fit into the indentations (141) on the other blade assembly, thereby allowing for a precise and clean cut.

FIG. 15 is a partial, side view of one iteration of the cutting edges. Here, one blade assembly has a triangular toothed cutting edge (150), which mates with the reciprocal cutting edge (151) on the mating blade assembly. The triangle points (150) on one blade assembly fit into the spaces between two triangles (151) on the other blade assembly, thereby allowing for a precise and clean cut. It should be noted that these are just two of the numerous iterations of decorative cuts made possible by this invention.

What I claim is:

1. A tool for cutting flat materials such as paper, photographs and cardboard, comprising:
a flat base plate with a cross-hatched grid of measuring lines,
a base plate cutting assembly comprising a base plate member, a base plate cutting edge which is a flat piece of metal attached to the plate by screws, rivets or similar means of attachment, where the fixed cutting edge is attached in a horizontal position and is shaped in a non-straight decorative pattern, a block which houses a bolt assembly, and a guide edge with ruled lines which serves to measure a piece of flat material to be cut and provide a solid baseline against which the flat material can rest during measuring and cutting,
a lever attached movably at one end of the base plate such that the lever can be raised or lowered such that it pivots about a point of attachment between the lever and the base plate,
a recessed bolt hole in the lever at the end of the lever attached to the base plate, where the recessed bolt hole is shaped and sized in the shape and size of a head of the bolt, thereby assuring that once the bolt is slid into the recessed bolt hole, it will not rotate,
a lock washer and a lock nut which are used to tighten the bolt, thereby ensuring that the lever is tightened sufficiently to line up the base plate cutting edge and the lever cutting edge, but not so tight as to unduly restrict its movement,
a lever cutting assembly comprising a lever member, a lever cutting edge which is a flat piece of metal attached to the plate by screws, rivets or similar means of attachment, where the fixed cutting edge is attached in a horizontal position and is shaped in a non-straight decorative pattern,
a safety barrier, and
a plurality of foot braces numbering at least three.

2. The tool of claim 1, where, the base plate cutting assembly is removable and exchangeable, and has a beveled surface on one side which can be slid into the base plate through a receiving slot, which is a track built into the lever, which also has a beveled edge which mates to the beveled edge of the base plate cutting assembly, and an indentation in the base plate which allows a user to easily grasp the base plate cutting assembly for removal once it has been attached.

3. The tool of claim 2, where, the lever cutting assembly is removable and exchangeable, and has a beveled surface on one side which can be slid into the lever arm through a receiving slot, which is a track built into the lever, which also has a beveled edge which mates to the beveled edge of the lever cutting assembly.

4. The tool of claim 3, where, the base plate member and the lever member are constructed from a rigid and yet flexible material which will maintain its shape and yet be flexible enough such that a lock at the end of the base plate member can flexibly slide over a lock projection on the base plate, thereby fixing the base member in position on the base plate, and a lock at the end of the lever member can flexibly slide over a over a lock projection on the lever, thereby fixing the base member in position on the lever, whereby the cutting edges of the lever member and the base plate member are aligned for cutting flat material laid on the base plate and aligned between the two cutting edges.

5. The base plate of claim 4, where, the base plate has one or more storage slots built into its underside which can accommodate one or more exchangeable lever members and base plate members.

6. The storage slots of claim 5, where, the storage slots have one beveled edge and are of a configuration which mates the configuration of the lever members and base plate members, thereby assuring a securing method of storage.

7. The storage slots of claim 6, where, each of the storage slots has a lock projection manufactured into it, over which the lock of the base plate member or lever member can slip, thereby locking the base plate member or lever member into the storage slot.

8. The storage slots of claim 7, where, the lock projections are semi-hemispherical in nature.

9. The device of claim 8, where, the base plate and lever are made of metal.

10. The device of claim 8, where, base plate, lever, base plate member and lever member are made of plastic.

11. The device of claim 8, where, the indentation in the base plate is rectangular in shape.

12. The device of claim 8, where, the indentation in the base plate is semi-circular in shape.

13. The device of claim 6, where, the base plate measures less than six inches.

14. The device of claim 6, where, the base plate measures between six inches and 12 inches on a side.

15. The device of claim 6, where the base plate measures between 12 inches and 24 inches on a side.

16. The device of claim 6, where, the base plate measures between 24 and 36 inches on a side.

17. The device of claim 6, where, the base plate measures greater than 36 inches on a side.
